(19) United States
(12) Patent Application Publication
(10) Pub. No.: US 2025/0026955 A1
(43) Pub. Date: Jan. 23, 2025

(54) WATERBORNE UV CURABLE COATING COMPOSITION

(71) Applicant: PPG Coatings (Tianjin) Co., Ltd., Tianjin (CN)

(72) Inventors: Xiangling Xu, Pittsburgh, PA (US); Daming Ruan, Shanghai (CN); Yurun Yang, Shanghai (CN); Yihua Wang, Shanghai (CN); Wenfu Yang, Jiangsu (CN); Siqi Gao, Tianjin (CN); Marchers Liu, Jiangsu (CN)

(73) Assignee: PPG Coatings (Tianjin) Co., Ltd., Tianjin (CN)

(21) Appl. No.: 18/713,241

(22) PCT Filed: Nov. 23, 2022
(86) PCT No.: PCT/CN2022/133669

§ 371 Date: May 24, 2024

(30) Foreign Application Priority Data
Nov. 24, 2021 (CN) 202111404521.X

(51) Int. Cl. C09D 175/14; C08J 7/04; C08K 5/07; C09D 7/63

(52) U.S. Cl. CPC C09D 175/14; C08J 7/0427; C08J 2369/00; C08J 2375/16; C08J 2483/12; C08K 5/07; C09D 7/63

(57) ABSTRACT

Disclosed is a waterborne UV-curable coating composition comprising a polyurethane resin and a PDMS-(meth) acrylate oligomer. Also disclosed is use of the waterborne UV-curable coating composition for coating a substrate and a substrate at least partially coated with the waterborne UV-curable coating composition.

### INVENTION FIELD

The present invention relates to the field of coating, in particular to a waterborne UV-curable coating.

### BACKGROUND

In 3C coatings including the coatings for computer, communication, and consumer electronics, a waterborne UV-curable coating for plastics, such as polycarbonate (PC), polycarbonate+acrylonitrile/butadiene/styrene copolymer (PC+ABS), polycarbonate+carbon fiber (PC+CF), and polycarbonate+glass fiber (PC+GF), commonly have a relatively poor stain resistance. To improve the stain resistance, persons skilled in the art have conducted extensive studies. At present, a widely used method is to prepare a polydimethylsiloxane (PDMS)-modified polyurethane resin, and then formulate a waterborne UV coating based on the modified polyurethane resin.

However, the preparation of a PDMS-modified polyurethane resin adapted to an application scenario requires a lot of research effort and cost. Moreover, it is also a difficulty in the art how to design and balance the formulation based on the prepared PDMS-modified polyurethane resin so that the coating has stain resistance without degrading other performances.

Therefore, there is an urgent practical need and potential commercial value for obtaining a waterborne UV-curable coating that has both stain resistance and other mechanical appearance properties in a simple and convenient way.

### SUMMARY OF THE INVENTION

The inventor has done a great number of studies and develops a waterborne UV-curable coating composition which has advantages of simple preparation and stain resistance, and at the same time can meet the requirements of various mechanical properties and appearance of 3C coatings.

The present invention provides a waterborne UV-curable coating composition comprising a polyurethane resin and a PDMS-(meth)acrylate oligomer.

The present invention further provides a coated substrate comprising a substrate and a waterborne UV curable coating composition deposited on at least a portion of the substrate, wherein the waterborne UV curable coating composition comprises a polyurethane resin and a PDMS-(meth)acrylate oligomer.

The present invention further provides use of a waterborne UV curable coating composition for coating a substrate, wherein the waterborne UV curable coating composition comprises a polyurethane resin and a PDMS-(meth)acrylate oligomer.

The characteristics and advantages of the present invention will be specifically presented in the detailed description of the following embodiments.

### BRIEF SUMMARY OF THE DRAWINGS

FIG. 1 shows the results of the waterborne UV-curable coatings according to the present invention and the coatings of the comparative examples in the stain resistance test.

### DETAILED DESCRIPTION OF THE INVENTION

As used herein, unless expressly stated otherwise, it should be understood that the numbers used in the description and claims, such as, those representing values, ranges, contents, or percentages, can be modified in all substances by the term “about”, even if this term is not clearly specified. Thus, unless indicated to the contrary, the numerical parameters listed in the description and claims herein are all approximations, and can be varied depending upon the properties to be obtained by the present invention.

Although the numerical ranges and parameters listing the broad scopes of the he present invention are approximations, the numerical records listed in the particular examples should be reported as precisely as possible. However, any numerical value inherently has a certain error. The error is an inevitable consequence of standard deviation found in its corresponding measurement method.

In addition, it should be understood that any numerical range described herein is intended to encompass all the sub-ranges subsumed therein. For example, a range of “1 to 10” is intended to include all the sub-ranges between (inclusive) the minimum value of 1 and the maximum value of 10, namely, it has a minimum value equal to or great than 1 and a maximum value equal to or less than 10.

In the present application, unless expressly stated otherwise, the use of singular includes a plural and the use of a plural includes a singular. Moreover, in the present application, unless expressly stated otherwise, the use of “or” means “and/or”, even though “and/or” can be expressly used in some cases. In addition, in the present application, unless expressly stated otherwise, the use of “a” or “an” means “at least a/an”. For example, “a” polymer, “a” coating, or the like refers to one or more of any of these items. Also, as those skilled in the art will recognize, feature(s) of one embodiment can be used together with other embodiments, even if it is not explicitly stated.

In the present application, the term “comprise” and similar terms mean comprising but being not limited to, which does not exclude any variation or addition. Furthermore, although the present invention has described the coating composition and/or method with “comprising” or similar terms, those coating compositions or the like can also be described as “consisting essentially of” or “consisting of”.

As used herein, the term “waterborne” means that the solvent in a coating composition comprises at least 50 wt % of water. The coating composition according to the present invention is a low-VOC coating composition. As used herein, the term “VOC(s) (volatile organic compound(s))” refers to any organic compound with a boiling point less than or equal to 250° C. (482° F.) as measured under the standard atmospheric pressure of 101.3 kPa. Organic solvents are often the main source of VOCs. The coating composition according to the present invention has a VOC content of <200 g/L, meeting the national standards that the waterborne coating should have a VOC less than 420 g/L. The VOC value can be determined by measuring the contents of various organic compound ingredients in the coating by gas chromatography, followed by adding up the contents of the various ingredients.

As used herein, the “UV-curable” means that materials in a coating composition are cured to form a film after exposure to ultraviolet (UV) radiation. Herein, the term “cured/curing/curable” refers to a process that a material becomes “fixed” to form an irreversible cross-linked network which no longer flows, melts, or dissolves. Herein, the term “cured/curing” can be interchangeably used with “cross-linked/cross-linking”.

The waterborne UV-curable coating composition according to the present invention can be used as a “topcoat”. The “topcoat” refers to an outermost coating in a multilayer coating system. When the waterborne UV-curable coating composition according to the present invention is used as a topcoat, it can be used in combination with any primer/basecoat as long as they are compatible with each other. Alternatively, the waterborne UV-curable coating composition according to the present invention can be directly applied onto the surface of a substrate without pre-applying any primer/basecoat.

The present invention provides a waterborne UV-curable coating composition comprising a polyurethane resin and a PDMS-(meth)acrylate oligomer.

The polyurethane resin used in the waterborne UV-curable coating composition according to the present invention refers to a polymer with repeating units comprising carbamate functional groups. The polyurethane can comprise carbamate-linked organic units selected from the group consisting of simple diols, polyester diols, polyether diols, and/or polycarbonate diols.

Suitably, the polyurethane resin can comprise a (meth)acrylate-functionalized polyurethane resin. The (meth)acrylate-functionalized polyurethane resin refers to a polyurethane resin comprising a (meth)acrylate-based functional group linked thereto. Suitably, the polyurethane resin can comprise 30 wt % to 100 wt % of (meth)acrylate-functionalized polyurethane resin based on the total weight of the resin, e.g., at least 40 wt %, such as, at least 50 wt % of (meth)acrylate-functionalized polyurethane resin, and/or at most 90 wt %, such as, at most 80 wt % of (meth)acrylate-functionalized polyurethane resin. Suitably, the polyurethane resin can comprise a (meth)acrylate-functionalized polyurethane resin and a different polyurethane resin, wherein the different polyurethane resin does not comprise (meth)acrylate-based functional groups.

The polyurethane resin suitable for the present invention can have a glass transition temperature (T_{g}) of −30° C. to 110° C., e.g., a T_{g} of 0° C. to 100° C., such as, a T_{g} of 20° C. to 80° C. The T_{g} can be determined by dynamic thermomechanical analysis (DMA) using a TA Instruments Q800 instrument with the following measuring parameters: a frequency of 10 Hz, an amplitude of 5 mm, and a temperature ramp of −100° C. to 250° C. The T_{g} is determined as the peak of the tan δ curve according to ASTM D7028.

Suitably, the polyurethane resin for the present application can be in the form of an aqueous dispersion with a solid content of about 30 wt % to 60 wt %. The term “solid content” refers to a percentage of the mass remaining after evaporation of solution in the mass of the original dispersion.

Based on the total weight of the waterborne UV-curable coating composition, the polyurethane resin can be present in the composition at an amount of about 10 wt % or greater, such as, about 20 wt % or greater, e.g., about 25 wt % or greater, and/or at an amount of about 70 wt % or less, such as, about 50 wt % or less, e.g., about 45 wt % or less. Based on the total weight of the waterborne UV-curable coating composition, the polyurethane resin can be present in a range of about 10 wt % to 70 wt %, such as, about 20 wt % to 50 wt %, e.g., about 25 wt % to 45 wt %, or in a range with any other combinations of these endpoints.

The PDMS-(meth)acrylate oligomer used in the waterborne UV-curable coating composition according to the present invention refers to an oligomer comprising a PDMS moiety and a (meth)acrylate moiety. The PDMS moiety comprises polydimethylsiloxane. The (meth)acrylate moiety can comprise one or more (meth)acrylate units.

Suitably, the PDMS-(meth)acrylate oligomer is water dispersible. The “water dispersible” means that the oligomer comprises hydrophilic groups so that it can be uniformly dispersed in water or an aqueous solvent without layer separation or the like phenomenon. Suitably, the PDMS-(meth)acrylate oligomer comprises polyoxyethylene and/or polyoxypropylene block moieties. Suitably, the PDMS-(meth)acrylate oligomer comprises a construction of (PDMS-polyoxyethylene and/or polyoxypropylene(meth)acrylate). Suitably, the PDMS-(meth)acrylate oligomer comprises a linear and/or branched structure. As used herein, the term “linear” means that the oligomer chain is substantially linear. As used herein, the term “branched” means that the oligomer chain comprises side chain(s) attached or otherwise covalently linked to the backbone.

The PDMS-(meth)acrylate oligomer suitable for the present invention has a number average molecular weight (Mn) of ≤10,000, e.g., Mn≤8,000, such as, Mn≤6,000. The Mn can be determined by gel permeation chromatography using a suitable standard, e.g., a polystyrene standard.

Based on the total weight of the waterborne UV-curable coating composition, the PDMS-(meth)acrylate oligomer can be present in the composition at an amount of about 0.1 wt % or greater, such as, about 0.5 wt % or greater, e.g., about 1 wt % or greater, and/or at an amount of about 10 wt % or less, such as, about 8 wt % or less, e.g., about 6 wt % or less. Based on the total weight of the waterborne UV-curable coating composition, the PDMS-(meth)acrylate oligomer can be present in the composition at an amount of about 0.1 wt % to 10 wt %, such as, about 0.5 wt % to 8 wt %, e.g., about 1 wt % to 6 wt %, or in a range of any other combinations using these endpoints.

In the waterborne UV-curable coating composition of the present invention, the polyurethane resin and the PDMS-(meth)acrylate oligomer can comprise at least 60 wt % of the total solid weight of the composition, suitably at least 80 wt %, e.g., at least 95 wt %, such as even 100 wt %. In the waterborne UV-curable coating composition of the present invention, the polyurethane resin can comprise at least 30 wt % of the total solid weight of the composition, e.g., at least 40 wt %, such as at least 50 wt %, suitably at least 60 wt %. e.g., at least 70 wt %, such as at least 80 wt %, such as at least 90 wt %, at least 95 wt %, or at least 98 wt %. Herein, the “total solid weight” refers to the total weight of the coating composition after solvent removal.

Suitably, in the waterborne UV-curable coating composition of the present invention, a weight ratio of the polyurethane resin to the PDMS-(meth)acrylate oligomer can be about 40:1 to 300:1, e.g., about 50:1 to 250:1, such as, about 80:1 to 150:1.

The waterborne UV-curable coating composition according to the present invention can further comprise a polyisocyanate. The polyisocyanate can consist of the following monomers: hexamethylene diisocyanate (HDI), isophorone diisocyanate (IPDI), and/or dicyclohexylmethane-4,4′-diisocyanate (HMDI). Suitably, the polyisocyanate can comprise multimer (at least trimer) of the following monomers: hexamethylene diisocyanate (HDI), isophorone diisocyanate (IPDI), and/or dicyclohexylmethane-4,4′-diisocyanate (HMDI). For example, the polyisocyanate can comprise HDI trimer and/or IPDI trimer.

Based on the total weight of the waterborne UV-curable coating composition, the polyisocyanate can be present in the composition at an amount of about 1 wt % to 10 wt %, such as, about 2 wt % to 6 wt %.

The waterborne UV-curable coating composition according to the present invention can further comprise a surfactant. Suitably, the surfactant used for the present invention comprises a non-ionic surfactant with wetting and defoaming properties. In general, based on total weight of the waterborne UV-curable coating composition, the matting agent can be present in the composition at an amount of about 0 wt % to 2 wt %.

The waterborne UV-curable coating composition according to the present invention can further comprise a matting agent. The matting agent comprises an inorganic matting agent and/or an organic matting agent. Suitably, the inorganic matting agent comprises a silica-based matting agent. The silica-based matting agent can comprise silica which has and/or has not undergone a surface treatment. The organic matting agent comprises a polymethylurea (PUM)-based matting agent. In general, based on total weight of the waterborne UV-curable coating composition, the matting agent can be present in the composition at an amount of about 0 wt % to 5 wt %, such as, about 1 wt % to 4 wt %.

The waterborne UV-curable coating composition according to the present invention can further comprise a photo-initiator. The photo-initiator can decompose under UV radiation and result in the polymerization of polymerizable oligomers and/or monomers to form a three-dimensional network structure. In general, based on total weight of the waterborne UV-curable coating composition, the photo-initiator can be present in the composition at an amount of about 1 wt % to 5 wt %.

The waterborne UV-curable coating composition according to the present invention can further comprise a substrate wetting agent. The wetting agent can improve the surface tension and permeability of the coating composition, better wet the coating layer, and improve the adhesion of the coating. Suitably, the wetting agent comprises an organosilicone-based and/or poly(meth)acrylate-based wetting agent. In general, based on total weight of the waterborne UV-curable coating composition, the substrate wetting agent can be present in the composition at an amount of about 0 wt % to 2 wt %.

The waterborne UV-curable coating composition according to the present invention can further comprise a thickening agent. The thickening agent can improve the viscosity of the coating, improve the thickness of wet film, and protect the coating from settling and layer separation. Suitably, the thickening agent comprises an alkali-soluble anionic thickening agent and an associative thickening agent. In general, based on total weight of the waterborne UV-curable coating composition, the thickening agent can be present in the composition at an amount of about 0 wt % to 5 wt %.

The waterborne UV-curable coating composition according to the present invention can further comprise organic solvent. The organic solvent can reduce the surface tension of the composition and increase the evaporation rate. Suitably, the organic solvent comprises alcohols, such as, butanol, isopropanol, 2-butoxyethanol, or the like. In general, based on total weight of the waterborne UV-curable coating composition, the organic solvent can be present in the composition at an amount of about 0 wt % to 5 wt %.

The waterborne UV-curable coating composition according to the present invention can further comprise 40 to 70 wt % of water.

The waterborne UV-curable coating composition according to the present invention can further comprise a (meth)acrylate resin and/or a polyester resin, or other film-forming substances. The waterborne UV-curable coating composition according to the present invention can further comprise one or more additional auxiliary ingredients (additives) including, but not limited to, rheology aids for improving the flowability and leveling property and reducing defects; preservatives for protecting the coating from going mouldy; pH adjusters for controlling the pH and stabilizing the coating; waxes for increasing the scratching resistance and improving the touch; pigments for imparting color, filling and/or wear resistance to the coating; and so on. If present, each type of auxiliary ingredient is present at an amount of at most about 5 wt % based on the total weight of the waterborne UV-curable coating composition.

The waterborne UV-curable coating composition according to the present invention can be prepared by mixing a composition comprising a polyurethane resin and a PDMS-(meth)acrylate oligomer uniformly at room temperature. As used herein, the “room temperature” refers to a temperature between 20° C. and 30° C., such as 22° C.

The present invention further provides use of a waterborne UV curable coating composition for coating a substrate, wherein the waterborne UV curable coating composition comprises a polyurethane resin and a PDMS-(meth)acrylate oligomer. As used herein, the term “substrate” refers to a material having a coarse or smooth surface with or without coating. The substrate comprises a plastic substrate. Suitable substrates comprise, but are not limited to, polycarbonate, polycarbonate+acrylonitrile/butadiene/styrene copolymer, polycarbonate+carbon fiber, and/or polycarbonate+glass fiber. The substrate can be a substrate for use in a vehicle display screen, a PET protective film of a mobile phone, a display screen for a computer, a keyboard, and/or a laptop housing.

The present invention further provides a substrate coated with a waterborne UV-curable coating composition which comprises a substrate and a waterborne UV curable coating composition deposited on at least a portion of the substrate, wherein the waterborne UV curable coating composition comprises a polyurethane resin and a PDMS-(meth)acrylate oligomer.

The coating composition of present invention can be coated by any known standard method in the art, e.g., spraying, dipping, roller coating, brush coating, or the like, and then cured under UV radiation to form a coating film. For example, it can be carried out by steps of baking the coating composition at 50° C. to 70° C. for about 10 min to 15 min to vaporize solvent and water, followed by performing a UV radiation with a UV energy of 800-1.200 mJ/cm² and a light radiation intensity of 100-200 mW/m². The coating generally has a film thickness in a range of 15-20 μm.

### EXAMPLES

The following examples are provided to further illustrate the present invention, but should not be construed to limit the present invention to the details of the examples. All parts and percentages in the following examples are by weight, unless otherwise stated.

### Examples 1-4

The waterborne UV-curable coating compositions Ex-1, Ex-2, Ex-3 and Ex-4 according to the present invention were prepared in line with the ingredients and amounts as listed in Table 1 below. In particular, the ingredients listed in the table were added under stirring into a container and mixed for about 30 min; and then the resultant mixture was sieved through a 200 mesh device.

TABLE 1
the waterborne UV-curable coating compositions Ex-1,
Ex-2, Ex-3, Ex-4 according to the present invention

| | Ex-1 | Ex-2 | Ex-3 | Ex-4 |
|---|---|---|---|---|
| Ingredients | (wt %) | (wt %) | (wt %) | (wt %) |
| polyurethane resin ^{a} | 44 | 44 | 44 | 44 |
| PDMS-(meth)acrylate oligomer | 0.9^{b1} | 0.9^{b2} | 0.9^{b3} | 0.4^{b1} |
| surfactant | 0.4 | 0.4 | 0.4 | 0.4 |
| substrate Wetting Agent^{d} | 0.5 | 0.5 | 0.5 | 0.5 |
| photo-initiator^{e} | 1.8 | 1.8 | 1.8 | 1.8 |
| thickening Agent^{f} | 0.4 | 0.4 | 0.4 | 0.4 |
| matting Agent^{g} | 4.4 | 4.4 | 4.4 | 4.4 |
| organic solvent^{h} | 3.5 | 3.5 | 3.5 | 3.5 |
| water | 44.1 | 44.1 | 44.1 | 44.6 |

^{a} comprising 30 wt % to 100 wt % of (meth)acrylate-functionalized polyurethane resin, and having a T_{g} of −30° C. to 100° C.;
^{b1} & ^{b2} & ^{b3}(PDMS-polyoxyethylene and/or polyoxypropylene-(meth)acrylate) oligomer, wherein ^{b1} has a Mₙ ≤ 6,000, ^{b2} is a linear structureand has a Mₙ ≤ 6,000, ^{b3} is a branched structure and has a Mₙ ≤ 6,000;
^{c}non-ionic surfactant, including SURFYNOL 104E;
^{d}comprising TWIN 4100 and WET 240;
^{e}comprising IHT-PI 184;
^{f}comprising VISCOPLUS 3030;
^{g}comprising NIPSIL E-1011;
^{h}alcoholic organic solvent including 2-butoxyethanol.

### Comparative Examples 1-4

The waterborne UV-curable coating compositions CE-1, CE-2, CE-3, and CE-4 according to the comparative examples were prepared in line with the ingredients and amounts as listed in Table 2 below. In particular, the ingredients listed in the table were added under stirring into a container and mixed for about 30 min; and then the resultant mixture was sieved through a 200 mesh device.

TABLE 2
the waterborne UV-curable coating compositions CE-1, CE-2,
CE-3, and CE-4 according to comparative examples

| | CE-1 | CE-2 | CE-3 | CE-4 |
|---|---|---|---|---|
| Ingredients | (wt %) | (wt %) | (wt %) | (wt %) |
| polyurethane resin ^{a} | 44.9 | 44 | 44 | 44 |
| silicon-containing | 0 | 0.9^{b4} | 0.9^{b5} | 0.9^{b6} |
| (meth)acrylate oligomer | | | | |
| surfactant^{c} | 0.4 | 0.4 | 0.4 | 0.4 |
| substrate wetting agent^{d} | 0.5 | 0.5 | 0.5 | 0.5 |
| photo-initiator^{e} | 1.8 | 1.8 | 1.8 | 1.8 |
| thickening agent^{f} | 0.4 | 0.4 | 0.4 | 0.4 |
| matting agent^{g} | 4.4 | 4.4 | 4.4 | 4.4 |
| organic solvent^{h} | 3.5 | 3.5 | 3.5 | 3.5 |
| water | 44.1 | 44.1 | 44.1 | 44.1 |

^{a} comprising 30 wt % to 100 wt % of (meth)acrylate-functionalized polyurethane resin, and having a T_{g} of −30° C. to 100° C.;
^{b4} & ^{b5} & ^{b6}are TECA-6 available from ShanFu, and OH ACR Di-50 and ACRT Di-25 available from Siltech, respectively;
^{c}non-ionic surfactant, including SURFYNOL 104E;
^{d}comprising TWIN 4100 and WET 240;
^{e}comprising IHT-PI 184;
^{f}comprising VISCOPLUS 3030;
^{g}comprising NIPSIL E-1011;
^{h}alcoholic organic solvent including 2-butoxyethanol.

### Test for Performance:

First, the waterborne UV-curable coating compositions Ex-1, Ex-2, Ex-3, Ex-4 according to the present invention and the waterborne UV-curable coating compositions CE-1, CE-2, CE-3 and CE-4 according to the comparative examples were applied onto a polycarbonate substrate, baked at about 60° C. for about 10 min, and then subject to UV radiation with a UV energy of 1,000 mJ/cm² and a light radiation intensity of 120 mW/cm².

The coated substrates were subject to various tests for performances as follows.

### 1-VOC

Herein, the VOC contents (without water, g/L) of the waterborne UV-curable coating compositions Ex-1, Ex-2, Ex-3, and Ex-4 according to the present invention were calculated by the following method.

For 1 g of the composition, the mass mᵢ of each ingredient in the composition, the mass mw of water in the composition, and the density ρₛ of the composition were measured, respectively.

Calculation was conducted according to the following equation,

$$ρ ( VOC ) \text{?} = [ \frac{{\sum }_{i = 1}^{\text{?}} {m}_{i}}{1 - {ρ}_{s} \times \frac{{m}_{w}}{{ρ}_{w}}} ] \times {ρ}_{s} \times 1 , 000$$

$$\text{?} \text{indicates text missing or illegible when filed}$$

wherein ρ_{w} is the density of water at 23° C.

| | Ex-1 | Ex-2 | Ex-3 | Ex-4 |
|---|---|---|---|---|
| VOC (without water, g/L) | <150 | <150 | <150 | <150 |

### 2-Gloss

The gloss of the resultant coatings were measured at 60° using a commercially available gloss meter BYK Micro-Gloss.

| | Ex-1 | Ex-2 | Ex-3 | Ex-4 | CE-1 | CE-2 | CE-3 | CE-4 |
|---|---|---|---|---|---|---|---|---|
| 60° | 5.3 | 5.8 | 5.7 | 5.3 | 5.4 | 5.4 | 5.3 | 5.6 |

### 3—Water Contact Angle

The water contact angle of the coating was measured using a commercially available optical contact angle meter.

| Ex-1 | Ex-2 | Ex-3 | Ex-4 | CE-1 | CE-2 | CE-3 | CE-4 |
|---|---|---|---|---|---|---|---|
| 94.3 | 99.6 | 98 | 93.5 | 84.6 | 89 | 105.3 | 94 |

### 4—Stain Resistance

In the present invention, the stain resistance of a coating was evaluated by: writing a mark with a Sharpie red pen on the coating, which was then dried at room temperature for 15 min; wiping the mark with dry paper towel for 5 times; and evaluating the stain resistance of the coating in accordance with the status of the mark after wiping. Specifically, the stain resistance was rated from 0 to 10, wherein 0 represented the worst, i.e., the red mark remained unchanged; and 10 represented the best, i.e., no residue of the red mark was left.

| Ex-1 | Ex-2 | Ex-3 | Ex-4 | CE-1 | CE-2 | CE-3 | CE-4 |
|---|---|---|---|---|---|---|---|
| Rating 7 | Rating 8 | Rating 9 | Rating 7 | Rating 0 | Rating 0 | Rating 1 | Rating 1 |

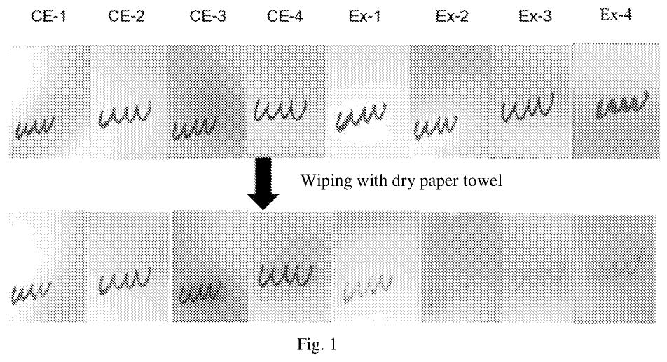

The stain resistance test results of the waterborne UV-curable coating compositions Ex-1, Ex-2, Ex-3, Ex-4 according to the present invention and the waterborne UV-curable coating compositions CE-1, CE-2, CE-3 and CE-4 of the comparative examples are also set forth in FIG. 1.

It can be seen that the waterborne UV-curable coating compositions provided in the present invention have superior stain resistance. At the same time, the waterborne UV-curable coating compositions according to the present invention can meet other requirements of appearance and mechanical properties.

Although the particular aspects of the present invention has been illustrated and described, it is obvious to persons skilled in the art that many other variations and modifications can be made without departing the spirit and scope of the present invention. Thus, the accompanying claims are intended to encompass all of these variations and modifications falling within the scope of the present invention.

1. A waterborne UV-curable coating composition comprising a polyurethane resin and a PDMS-(meth)acrylate oligomer.

2. The coating composition according to claim 1, wherein the PDMS-(meth)acrylate oligomer is water dispersible.

3. The coating composition according to claim 1, wherein the PDMS-(meth)acrylate oligomer comprises polyoxyethylene and/or polyoxypropylene block moieties.

4. The coating composition according to claim 1, wherein the PDMS-(meth)acrylate oligomer comprises a construction of (PDMS-polyoxyethylene and/or polyoxypropylene-(meth)acrylate).

5. The coating composition according to claim 1, wherein the PDMS-(meth)acrylate oligomer comprises a linear or branched structure.

6. The coating composition according to claim 1, wherein the PDMS-(meth)acrylate oligomer has a number average molecular weight≤10,000.

7. The coating composition according to claim 1, wherein the composition comprises less than 10 wt % of the PDMS-(meth)acrylate oligomer based on the total weight of the composition.

8. The coating composition according to claim 1, wherein the polyurethane resin comprises a (meth)acrylate-functionalized polyurethane resin.

9. The coating composition according to claim 1, wherein the polyurethane resin comprises 30-100 wt % of (meth)acrylate-functionalized polyurethane resin based on the total weight of the polyurethane resin.

10. The coating composition according to claim 1, wherein the polyurethane resin has a glass transition temperature of −30° C. to 110° C.

11. The coating composition according to claim 1, wherein the polyurethane resin constitutes at least 30 wt % of the total solid weight of the composition.

12. The coating composition according to claim 1, wherein the polyurethane resin and the PDMS-(meth)acrylate oligomer constitute at least 80 wt % of the total solid weight of the composition.

13. The coating composition according to claim 1, wherein the weight ratio of the polyurethane resin to the PDMS-(meth)acrylate oligomer comprises 40:1 to 300:1.

14. The coating composition according to claim 1, having a VOC content of less than 200 g/L, as measured without water.

15. A coated substrate comprising a substrate and a waterborne UV-curable coating composition deposited on at least a portion of the substrate, wherein the waterborne UV-curable coating composition comprises a polyurethane resin and a PDMS-(meth)acrylate oligomer.

16. The coated substrate of claim 15, wherein the substrate comprises polycarbonate, polycarbonate+acrylonitrile/butadiene/styrene copolymer, polycarbonate+carbon fiber, and/or polycarbonate+glass fiber.

17. The coated substrate according to claim 15, wherein the substrate is a substrate for use in a vehicle display screen, a PET protective film of a mobile phone, a display screen for a computer, a keyboard, and/or a laptop housing.

18-20. (canceled)
